(19) United States
(12) Patent Application Publication
(10) Pub. No.: US 2012/0287049 A1
(43) Pub. Date: Nov. 15, 2012

(54) GRAVITY SENSING INPUT SYSTEM, GRAVITY SENSING INPUT METHOD AND ELECTRONIC DEVICE THEREOF

(75) Inventor: Xin Feng, Nanjing (CN)

(73) Assignees: INVENTEC APPLIANCES (PUDONG) CORPORATION, Shanghai (CN); INVENTEC APPLIANCES (JIANGNING) CORPORATION, Nanjing (CN); INVENTEC APPLIANCES CORP., New Taipei City (TW)

(21) Appl. No.: 13/448,414

(22) Filed: Apr. 17, 2012

(30) Foreign Application Priority Data
May 13, 2011 (CN) 201110134103.3

(51) Int. Cl. G06F 3/02; G06F 3/01

(52) U.S. Cl. 345/168; 345/156

(57) ABSTRACT

A gravity sensing input system, a gravity sensing input method and an electronic device thereof are proposed. The gravity sensing input system includes a gravity sensor, an input module, a processing module and an output module. The gravity sensor detects a gravitational acceleration of the electronic device tilted towards a direction. The input module includes a plurality of input interfaces, where each one of the input interfaces corresponds to a plurality of letters, and the input module receives an input signal through one of the input interfaces. The processing module calculates an inclined angle between the electronic device and a reference plane according to the gravitational acceleration, and determines which one of the letters is selected according to the inclined angle and the input interface corresponding to the received input signal. Additionally, the output module outputs the letter selected by the processing module.

### CROSS-REFERENCE TO RELATED APPLICATION

This application claims the priority benefit of China application serial no. 201110134103.3, filed on May 13, 2011. The entirety of the above-mentioned patent application is hereby incorporated by reference herein and made a part of this specification.

### BACKGROUND

1. Field of the Invention

The invention relates to a gravity sensing input system and a gravity sensing input method thereof, and, particularly, the invention is related to a gravity sensing input system, a gravity sensing input method and an electronic device thereof, which sets angle ranges corresponding to letters, then uses a XYZ-axes gravity detection technology of a three-axes gravity sensor to calculate an inclined angle between each of the axes and a reference plane, and further determines the letter to be used according to the inclined angles and an input signal from a user, so as to achieve fast inputting letters.

2. Description of Related Art

Gravity sensors (abbreviated as G-sensor thereinafter) can detect a variation in gravitational accelerations. The gravitational acceleration is the force applied to an object during the object is being accelerated. The force can be any variations such as oscillation, falling, ascending and descending, and can be converted to electrical or electronic signals by the G-sensor. Then, through calculation and analysis through a microcontroller, functionality corresponding to the variations in a predetermined program can be achieved. For example, a MP3 player can change to play the next or the last song according to swing directions of the user. Also, the MP3 player can calculate movement steps of the user when the MP3 player is placed into a pocket. For example, IBM™ series computers are also embedded with G-sensors, where each G-sensor can assist in immediately protecting hard disk drive for preventing the hard disk drive from any damage in a computer when the G-sensor detects a violation acceleration (for example, the computer stars to fall). To put it simply, the G-sensor can be an intelligent gravity detection system, and the G-sensor can detect a current status of the hard disk drive when the G-sensor is applied on the hard disk drive. When an accident falling occurs, a corresponding acceleration is generated, and thus the hard disk drive can detect the acceleration to make a magnetic reader thereof to automatically restore to the predetermined position, thereby making a disk body and the magnetic reader thereof separated. Accordingly, the hard disk drive is effectively protected from any accident shock during a reading operation or a writing operation.

A mobile phone with a G-sensor can be used to perform corresponding software applications according to movements of the user. For example, in a mobile phone game, when the user waves the mobile phone, the game can have corresponding reactions such as a micro-electro-mechanical-system (MEMS) in a home entertainment game console Wii™.

However, though the G-sensor is widely applied in every kind of electronic devices, there is currently no electronic device implemented with the G-sensor to achieve quickly inputting letters. Therefore, a gravity sensing input system is developed as disclosed in the invention, which is expected to achieve quickly inputting letters.

### SUMMARY

The invention is directed to a gravity sensing input system, a gravity sensing input method and an electronic device thereof. According to an objective of the invention, the gravity sensing input system uses the G-sensor to achieve quickly inputting letters.

According to another objective of the invention, the gravity sensing input system and the method thereof are provided, which is suitable for an electronic device, and includes a gravity sensor, an input module, a processing module and an output module. The gravity sensor detects a gravitational acceleration of the electronic device tilted towards a direction. The input module includes a plurality of input interfaces, where each one of the input interfaces corresponds to a plurality of letters, and the input module receives an input signal through one of the input interfaces. The processing module is connected to the gravity sensor and the input module, and calculates an inclined angle between the electronic device and a reference plane according to the gravitational acceleration, and the processing module further determines which one of the letters is selected according to the inclined angle and the input interface corresponding to the received input signal. The output module is connected to the processing module, and outputs the letter selected by the processing module.

According to an embodiment of the invention, the proposed gravity sensing input system in the invention also includes a storage module, which is connected to the processing module, for storing the letters.

According to an embodiment of the invention, the proposed gravity sensing input system in the invention also includes a setting module, which is connected to the processing module, for setting an angle range corresponding to each one of the letters.

According to an embodiment of the invention, in the letters corresponding to each one of the input interfaces, different letters corresponding to one of the input interface are corresponding to different angle ranges.

According to an embodiment of the invention, the setting module is connected to the processing module, and the processing module determines which one of the letters is selected by determining the inclined angle corresponding to which one of the angle ranges, and then by determining which input interface corresponding to the input signal is received.

According to an embodiment of the invention, each of the input interfaces is a button or a keypad.

According to an embodiment of the invention, the electronic device also includes a display screen, and the reference plane can be a plane in parallel with the display screen.

According to another objective of the invention, there is proposed a gravity sensing input method, which is suitable for an electronic device, and the gravity sensing input method includes following steps: detecting a gravitational acceleration of the electronic device tilted towards a direction through a gravity sensor; receiving an input signal through one of multiple input interfaces, wherein each one of the input interfaces corresponds to a plurality of letters; calculating an inclined angle between the electronic device and a reference plane according to the gravitational acceleration; and determining, by a processing module, which one of the letters is selected according to the inclined angle and the input interface corresponding to the received input signal.

According to another objective of the invention, there is proposed an electronic device, which includes a main body and a gravity sensing input system. The gravity sensing input system includes a gravity sensor, an input module, a processing module and an output module. The gravity sensor detects a gravitational acceleration of the main body tilted towards a direction. The input module includes a plurality of input interfaces, where each one of the input interfaces corresponds to a plurality of letters, and the input module is receives an input signal through one of the input interfaces. The processing module is connected to the gravity sensor and the input module, and calculates an inclined angle between the main body and a reference plane according to the gravitational acceleration, and the processing module further determines which one of the letters is selected according to the inclined angle and the input interface corresponding to the received input signal. The output module is connected to the processing module, and outputs the letter selected by the processing module.

Based upon the aforementioned descriptions, the gravity sensing input system, the gravity sensing input method, and the electronic device thereof can enable the user to press only one button to quickly input the desired letter, after the G-sensor detects gravitational acceleration and the processor calculates the angle, without selecting the letter by the user after the user presses down the button. Accordingly, e required for inputting letters by the user can be saved, thereby enhancing speed of input letters.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a gravity sensing input system according to an embodiment of the invention.

FIG. 2 is a flowchart of a gravity sensing input method of the gravity sensing input system according to a first embodiment of the invention.

FIG. 3 is a flowchart of a gravity sensing input method of the gravity sensing input system according to a second embodiment of the invention.

FIG. 4a is a first schematic diagram of a gravity sensing input method of the gravity sensing input system according to a third embodiment of the invention.

FIG. 4b is a second schematic diagram of a gravity sensing input method of the gravity sensing input system according to the third embodiment of the invention.

FIG. 4c is a third schematic diagram of a gravity sensing input method of the gravity sensing input system according to the third embodiment of the invention.

FIG. 4d is a fourth schematic diagram of a gravity sensing input method of the gravity sensing input system according to the third embodiment of the invention.

FIG. 4e is a fifth schematic diagram of a gravity sensing input method of the gravity sensing input system according to the third embodiment of the invention.

FIG. 4f is a sixth schematic diagram of a gravity sensing input method of the gravity sensing input system according to the third embodiment of the invention.

FIG. 5 is a functional block diagram of an electronic device having a gravity sensing input system according to an embodiment of the invention.

### DETAILED DESCRIPTION OF DISCLOSED EMBODIMENTS

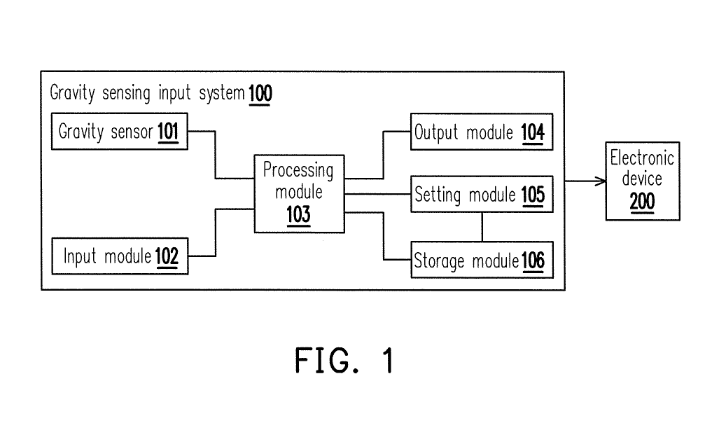

FIG. 1 is a functional block diagram of a gravity sensing input system according to an embodiment of the invention. Referring to FIG. 1, a gravity sensing input system 100 includes a gravity sensor 101, an input module 102, a processing module 103, an output module 104, a setting module 105 and a storage module 106. The processing module 103 is connected to the gravity sensor 101, the input module 102, the output module 104, the setting module 105 and the storage module 106. The setting module 105 and the storage module 106 are also connected with each other. The gravity sensing input system 100 is suitable for an electronic device 200 such as a mobile phone, a personal digital assistant or a flat panel computer.

Before operating the gravity sensing input system 100, the setting module 105 firstly sets an angle range corresponding to each one of letters in the storage module 106. The input module 102 includes a plurality of input interfaces, where each one of the input interfaces corresponds to a plurality of letters, and different letters corresponding to one of the input interfaces are corresponding to different angle ranges. When the user of the electronic device 200 turns the electronic device 200 tilted towards to a direction, the gravity sensor 101 can detect a gravitational acceleration of the electronic device 200. Then, the processing module 103 can calculate an inclined angle between the electronic device 200 and a reference plane according to the gravitational acceleration, and further determine which one of the letters is selected according to the inclined angle and the input interface corresponding to the received input signal. Further, the input module 102 provides an input signal of the user through one of the input interfaces, and the processing module 103 can determine to select the corresponding letter according to the calculated inclined angle and the input signal received through the input interface. Finally, the output interface 104 outputs and displays the letter.

In the present embodiment, the gravity sensor 101 is a G-sensor. The gravity sensing input system 100 mainly uses the gravity sensor 101 to detect gravity accelerations respectively in a X-axis, a Y-axis and a Z-axis, and further calculates the gravity accelerations according to included angles respectively between the X-axis, the Y-axis and the Z-axis and a horizontal plane (i.e., a reference plane in the present embodiment), so as to achieve quickly inputting letters. The calculation method of included angles respectively between the three axes and the horizontal plane firstly requires definitions of the included angles Pitch/Roll/Theta respectively between the three axes and the horizontal plane:

Pitch(ρ): an included angle between the X-axis and the horizontal plane;

Roll(φ): an included angle between the Y-axis and the horizontal plane; and

Theta(θ): an included angle between the Z-axis and the horizontal plane.

The calculation method of the Pitch/Roll/Theta angles are described below:

Pitch(ρ)=a tan(Ax/sqrt(pow(Ay,2)+pow(Az,2)));

Roll(φ)=a tan(Ax/sqrt(pow(Ax,2)+pow(Az,2))); and

Theta(θ)=a tan(sqrt(pow(Ax,2)+pow(Az,2))),

where, definitions of atan(·), sqrt(·) and pow(·) can be referred to American National Standard Institute (ANSI) standard function library, and Ax, Ay and Az are respectively gravitational accelerations in X-axis, Y-axis and Z-axis. The values of Ax, Ay and Az are output by the G-sensor. To be illustrated more clearly, the definition of atan(A) returns a principal value of an arc tangent of A, the definition of pow(A, 2) returns a value of A to the power of 2, and the definition of sqrt(A) returns a squared root value of A.

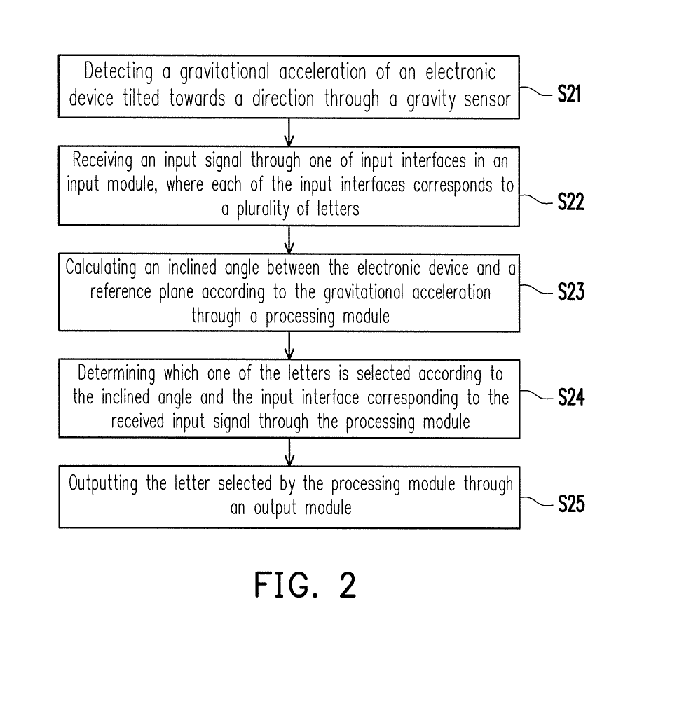

FIG. 2 is a flowchart of a gravity sensing input method of the gravity sensing input system according to a first embodiment of the invention. Referring to FIG. 2, the gravity sensing input method is suitable for an electronic device and includes following steps of: step S21: detecting a gravitational acceleration of an electronic device tilted towards a direction through a gravity sensor; step S22: receiving an input signal through one of input interfaces by an input module, where each of the input interfaces corresponds to a plurality of letters; step S23: calculating an inclined angle between the electronic device and a reference plane according to the gravitational acceleration through a processing module; step S24: determining which one of the letters is selected according to the inclined angle and the input interface corresponding to the received input signal through the processing module; and step S25: outputting the letter selected by the processing module through an output module. Each of the letters is firstly set with a corresponding angle range by a setting module. Each of the input interfaces corresponds to a plurality of letters, in letters corresponding to each of the input interfaces, different letters corresponding to one of the input interfaces are corresponding to different angle ranges. Thus, the processing module determines the angle range corresponding to the inclined angle, and firstly determines which letters the user is desired to select according to the determined angle range. Then, the processing module determines to select one letter from the letters according to an input signal of one of the input interfaces selected by the user, and then outputs the selected letter through the output module.

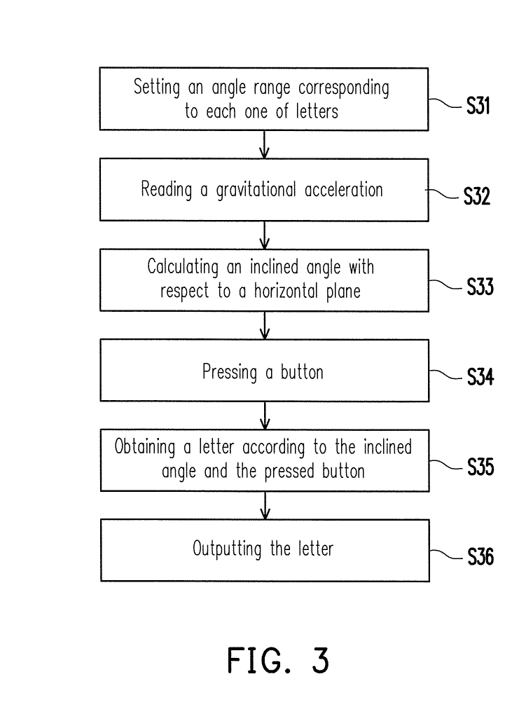

FIG. 3 is a flowchart of a gravity sensing input method of the gravity sensing input system according to a second embodiment of the invention. Referring to FIG. 3, the gravity sensing input method is suitable for an electronic device and includes following steps of: step S31: setting an angle range corresponding to each one of letters through the setting module; step S32: the G-sensor detects a gravitational acceleration of the electronic device being turned tilted towards a direction; step S33: the processing module calculates a current inclined angle of the electronic device with respect to a horizontal plane, and determines the angle range to which the current inclined angle corresponds, and then determines which letters the user is desired to select according to the corresponding angle range in advance; step S34: the user presses one of the buttons of the electronic device, where each one of the buttons corresponds to a plurality of letters, and each one of the letters, corresponding to each one of the butters, corresponds to different angle ranges; step S35: the processing module further selects one letter from the determined letters according to both the current inclined angle and the button pressed by the user; and step S36: the output module outputs the selected letter.

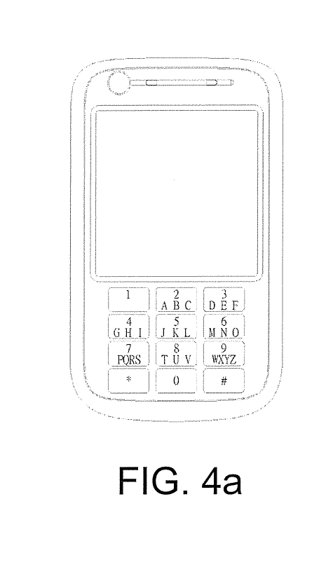

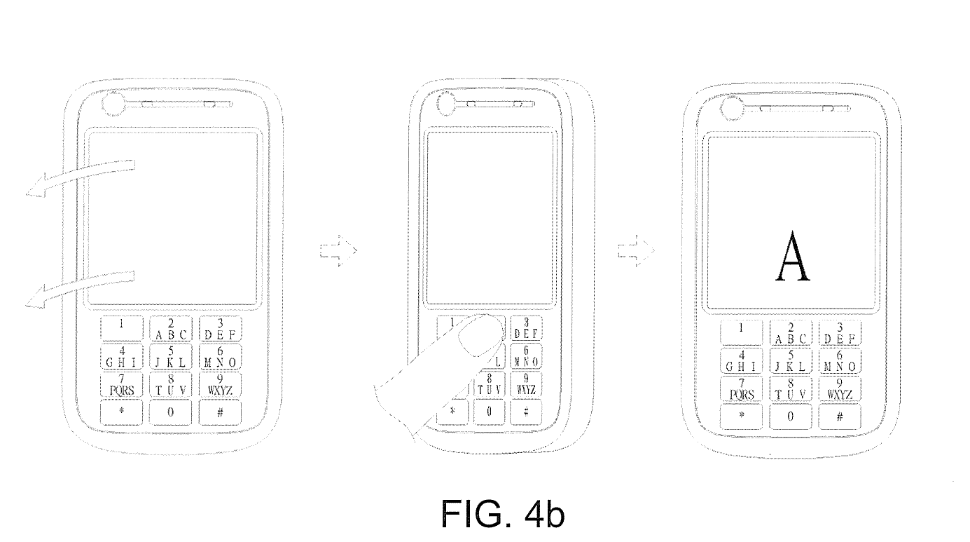

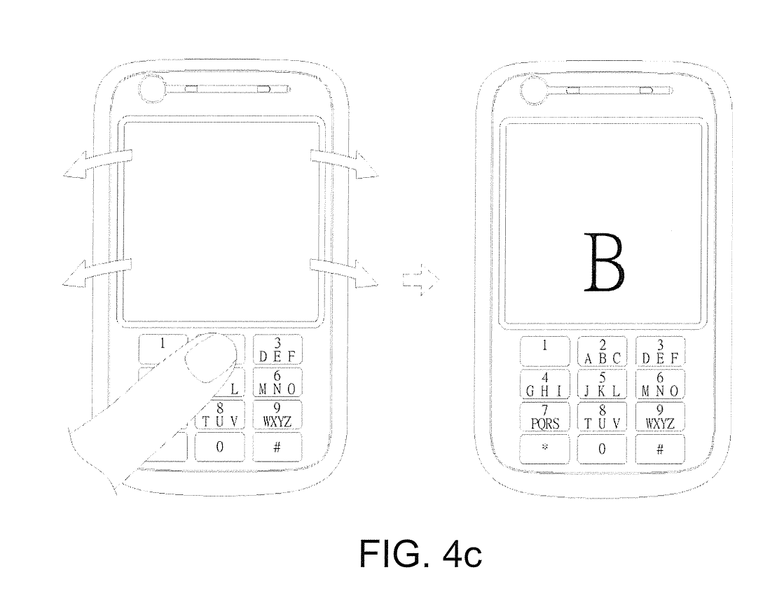

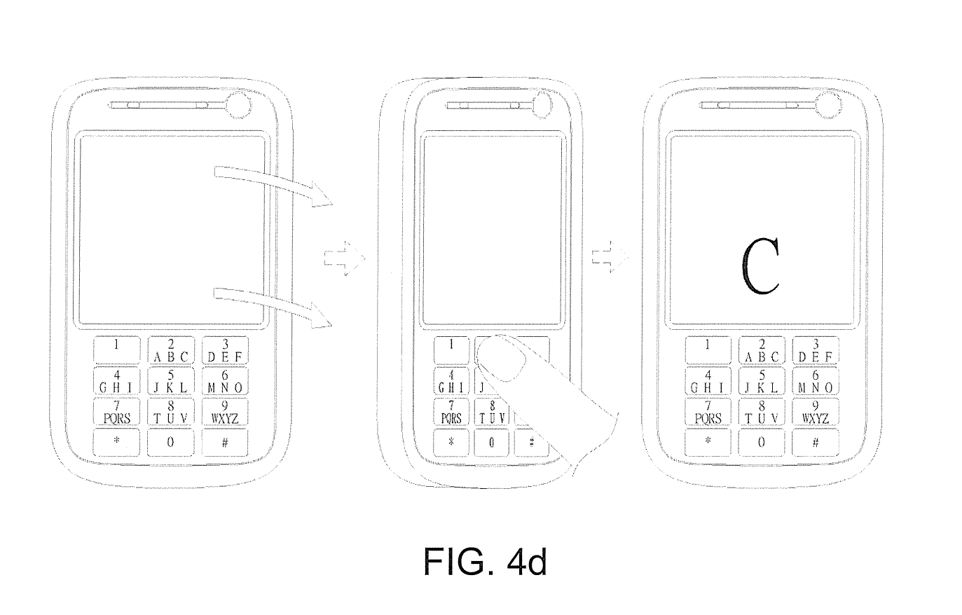

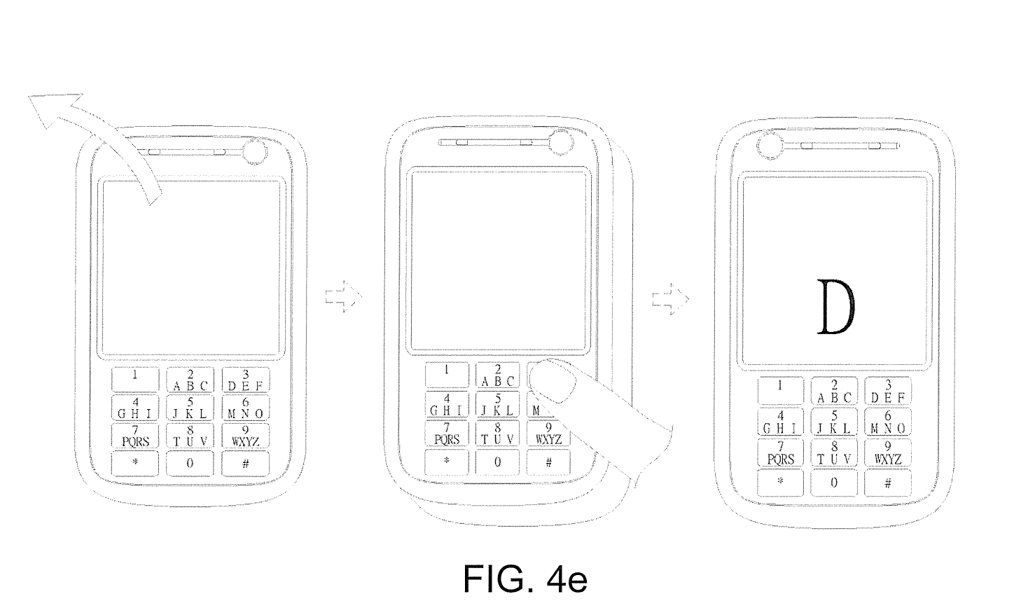

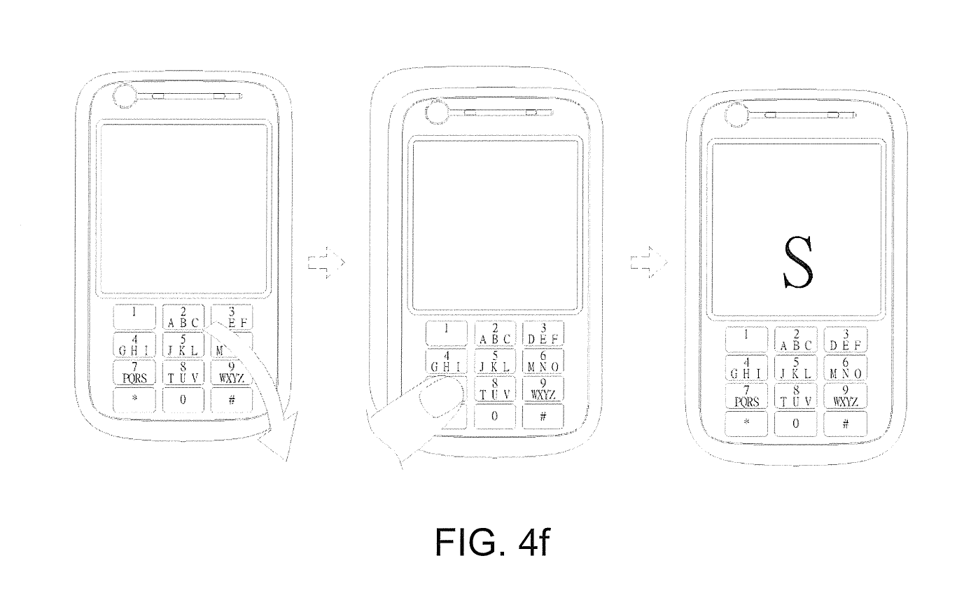

FIG. 4a to FIG. 4f are respectively a first schematic diagram, a second schematic diagram, a third schematic diagram, a fourth schematic diagram, a fifth schematic diagram and a sixth schematic diagram of a gravity sensing input method of the gravity sensing input system according to the third embodiment of the invention. Referring to FIG. 4a, the first schematic diagram clearly shows a mobile phone, and the mobile phone is embedded with the gravity sensing input system disclosed in the invention. Buttons of the mobile phone includes number keys 0-9, a “*” key and a “#” key. The number key “2” corresponds to letters “A”, “B” and “C”. The number key “3” corresponds to letters “D”, “E” and “F”. The number key “4” corresponds to letters “G”, “H” and “I”. The number key “5” corresponds to letters “J”, “K” and “L”. The number key “6” corresponds to letters “M”, “N” and “O”. The number key “7” corresponds to letters “P”, “Q”, “R” and “S”. The number key “8” corresponds to letters “T”, “U” and “V”. The number key “9” corresponds to letters “X”, “Y” and “Z”. Each of the letters have been set a corresponding angle range by the setting module, where different letters corresponding to each number key have different corresponding angle ranges. For example, the letters “A”, “B” and “C” corresponding to the number key “2” can have different corresponding angle ranges, but the letters “A”, “B” and “C” may have the angle range the same as that of other letters corresponding to other number keys. For example, the letter “A” may have the same angle range as that of the letters “D”, “G”, “J” and “M”, and the same concepts can be applied to other letters shown on the buttons of the electronic device.

Referring to FIG. 4b, in the second schematic diagram, the user activates the gravity sensing input system in the mobile phone, and starts to use the mobile phone to input letter(s). At the same time, when the user is desired to input a letter “A”, the user can turn the mobile phone leftward with an inclined angle. Then, the G-sensor of the gravity sensing input system can detect the gravitational accelerations on three axes. The processor in the mobile phone thus can calculate the inclined angles between three axes and the horizontal plane according to the gravitational accelerations, and then determines one of the preset angles ranges to which the inclined angel corresponds. In this case shown in FIG. 4b, the letters in the angle range can include the letters “A”, “D”, “G”, “J”, “M”, “P”, “T” and “W”. Next, when the user presses the number key “2” on the mobile phone, the processor can determine to select the letter “A” according to both the number key “2” pressed by the user and the angle range which the inclined angle corresponds to, and then outputs the letter “A” on a display screen of the mobile phone. Suppose the user presses the number key “3” on the mobile phone, then the letter “D” is selected and outputted; suppose the number key “4” is pressed, the letter “G” is selected and outputted; suppose the number key “5” is pressed, the letter “J” is selected and outputted; suppose the number key “6” is pressed, the letter “M” is selected and outputted; suppose the number key “7” is pressed, the letter “P” is selected and outputted; suppose the number key “8” is pressed, the letter “T” is selected and outputted; and suppose the number key “9” is pressed, the letter “W” is selected and outputted.

Referring to FIG. 4c, in the third schematic diagram, when the user is desired to input the letter “B”, the user can keep the mobile pone without turning, or slightly turns the mobile phone leftward or rightward with a small angle. Then, the G-sensor of the gravity sensing input system can detect the gravitational accelerations on three axes, the processor in the mobile phone can calculate the inclined angles between three axes and the horizontal plane according to the gravitational accelerations, and then determines one of the preset angles ranges to which the inclined angel corresponds. In this case shown in FIG. 4c, the letters in the angle range can include the letters “B”, “E”, “H”, “K”, “N”, “Q” (when the mobile phone is turned leftward inclined with a small angle), or “R” (when the mobile phone is turned rightward inclined with a small angle), “U” and “X” (when the mobile phone is turned leftward inclined with a small angle) or “Y” (when the mobile phone is turned rightward inclined with a small angle). Next, when the user presses the number key “2” on the mobile phone, the processor can determine to select the letter “B” according to both the number key “2” pressed by the user and the angle range which the inclined angle corresponds to, and then outputs the letter “B” on a display screen of the mobile phone. Suppose the user presses the number key “3” on the mobile phone, then the letter “E” is selected and outputted; suppose the number key “4” is pressed, the letter “H” is selected and outputted; suppose the number key “5” is pressed, the letter “K” is selected and outputted; suppose the number key “6” is pressed, the letter “N” is selected and outputted; suppose the number key “7” is pressed, the letter “Q” or “R” is selected and outputted; suppose the number key “8” is pressed, the letter “U” is selected and outputted; and suppose the number key “9” is pressed, the letter “X” or “Y” is selected and outputted.

Referring to FIG. 4d, in the fourth schematic diagram, when the user is desired to input the letter “B”, the user can keep the mobile pone without turning, or slightly turns the mobile phone leftward or rightward with a small angle. Then, the G-sensor of the gravity sensing input system can detect the gravitational accelerations on three axes, the processor in the mobile phone can calculate the inclined angles between three axes and the horizontal plane according to the gravitational accelerations, and then determines one of the preset angles ranges to which the inclined angel corresponds. In this case shown in FIG. 4c, the letters in the angle range can include the letters “C”, “F”, “I”, “L”, “O”, “S”, “V” and “Z”. Next, when the user presses the number key “2” on the mobile phone, the processor can determine to select the letter “C” according to both the number key “2” pressed by the user and the angle range which the inclined angle corresponds to, and then outputs the letter “C” on a display screen of the mobile phone. Suppose the user presses the number key “3” on the mobile phone, then the letter “F” is selected and outputted; suppose the number key “4” is pressed, the letter “I” is selected and outputted; suppose the number key “5” is pressed, the letter “L” is selected and outputted; suppose the number key “6” is pressed, the letter “O” is selected and outputted; suppose the number key “7” is pressed, the letter “S” is selected and outputted; suppose the number key “8” is pressed, the letter “V” is selected and outputted; and suppose the number key “9” is pressed, the letter “Z” is selected and outputted.

Referring to both FIGS. 4e-4f, in the fifth and the sixth schematic diagram, when the user is desired to input letter(s), it is not necessary for the user to turn the mobile phone in a manner with an exactly rightward inclined or exactly leftward inclined as shown in previously described FIGS. 4b-4c, in order to input the desired letters. As can be understood from the fifth schematic diagram, if the user firstly turns the mobile phone both leftward and upward simultaneously with an inclined angle, and then presses the number key “3”, the gravity sensing input system can still determine that the letter which the user desires to input is the letter “D”. On the other hand, in the sixth schematic diagram, when the user firstly turns the mobile phone both rightward and downward simultaneously with an inclined angle, and then presses the number key “7”, the gravity sensing input system can still determine that the letter which the user desires to input is the letter “S”. As can be understood from the aforementioned descriptions, the gravity sensing input system can determines the inclined angle between three axes and the horizontal plane when the mobile is turned with an inclined angle by the user towards any direction. Then, the gravity sensing input system can determine an angle range corresponding to the inclined angle, and quickly obtain the letter which the user desires to input according to the button pressed by the user.

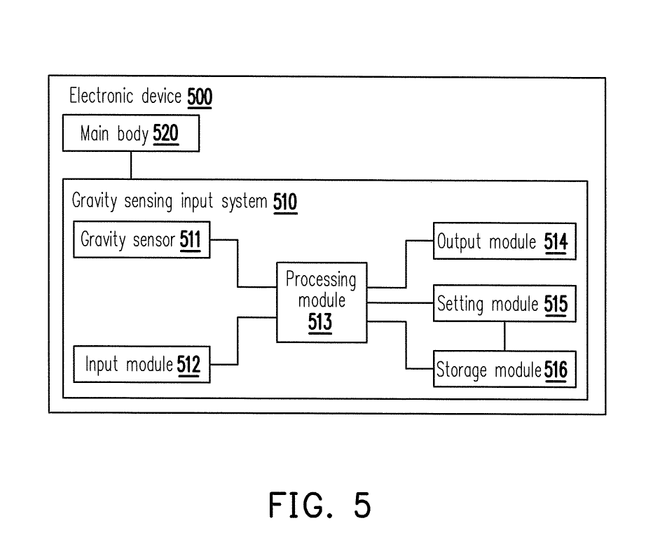

FIG. 5 is a functional block diagram of an electronic device having a gravity sensing input system according to an embodiment of the invention. Referring to FIG. 5, an electronic device 500 includes a main body 520 and a gravity sensing input system 510. In the present embodiment, the gravity sensing input system 510 is connected to the main body 520. However, in other embodiments of the invention, the main body 520 may include the gravity sensing input system 510, but there is no electrical connection between the gravity sensing input system 510 and the main body 520.

The gravity sensing input system 510 includes a gravity sensor 511, an input module 512, a processing module 513, an output module 514, a setting module 515 and a storage module 516. The gravity sensor 511 detects a gravitational acceleration of the main body 520 tilted towards a direction. The input module 512 includes a plurality of input interfaces similar as to the buttons shown in FIG. 4a, where each one of the input interfaces corresponds to a plurality of letters, and the input module is receives an input signal through one of the input interfaces. The processing module 513 is connected to the gravity sensor 511 and the input module 512, and calculates an inclined angle between the main body 520 and a reference plane according to the gravitational acceleration. For example, the reference plane is the horizontal plane, but the invention is not limited thereto. The processing module 513 further determines which one of the letters is selected according to the inclined angle and the input interface corresponding to the received input signal. The output module 514 is connected to the processing module 513, and outputs the letter selected by the processing module 513.

The storage module 515 is connected to the processing module 513 and stores the letters. The setting module 515 is connected to the storage module 516 and sets an angle range corresponding to each one of the letters. In the present embodiment, different letters corresponding to one of the input interface are corresponding to the different angle ranges. Further, the processing module 513 determines which one of the letters is selected by determining the inclined angle corresponding to which one of the angle ranges, and then by determining which input interface corresponding to the input signal is received. In the present embodiment, each of the input interfaces is a button or a keypad.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A gravity sensing input system, suitable for an electronic device, comprising:
a gravity sensor configured for detecting a gravitational acceleration of the electronic device tilted towards a direction;
an input module, comprising a plurality of input interfaces, wherein each one of the input interfaces corresponds to a plurality of letters, and the input module is configured for receiving an input signal through one of the input interfaces;
a processing module, connected to the gravity sensor and the input module, configured to calculate an inclined angle between the electronic device and a reference plane according to the gravitational acceleration, and determine which one of the letters is selected according to the inclined angle and the input interface corresponding to the received input signal; and
an output module, connected to the processing module, configured for outputting the letter selected by the processing module.

2. The gravity sensing input system as claimed in claim 1, further comprising:
a storage module, connected to the processing module, configured for storing the letters.

3. The gravity sensing input system as claimed in claim 2, further comprising:
a setting module, connected to the storage module, configured for setting an angle range corresponding to each one of the letters.

4. The gravity sensing input system as claimed in claim 3, wherein different letters corresponding to one of the input interface are corresponding to different angle ranges.

5. The gravity sensing input system as claimed in claim 4, wherein the setting module is connected to the processing module, and the processing module determines which one of the letters is selected by determining the inclined angle corresponding to which one of the angle ranges, and then by determining which input interface corresponding to the input signal is received.

6. The gravity sensing input system as claimed in claim 1, wherein each of the input interfaces is a button or a keypad.

7. A gravity sensing input method, suitable for an electronic device, wherein the gravity sensing input method comprises following steps:
detecting a gravitational acceleration of the electronic device tilted towards a direction through a gravity sensor;
receiving an input signal through one of multiple input interfaces, wherein each one of the input interfaces corresponds to a plurality of letters;
calculating an inclined angle between the electronic device and a reference plane according to the gravitational acceleration; and
determining, by a processing module, which one of the letters is selected according to the inclined angle and the input interface corresponding to the received input signal.

8. The gravity sensing input method as claimed in claim 7, further comprising:
storing each one of the letters.

9. The gravity sensing input method as claimed in claim 8, further comprising:
setting an angle range corresponding to each one of the letters.

10. The gravity sensing input method as claimed in claim 9, wherein the different letters corresponding to one of the input interface are corresponding to the different angle ranges.

11. The gravity sensing input method as claimed in claim 10, further comprising:
determining the inclined angle corresponding to which one of the angle ranges; and
determining which input interface corresponding to the input signal is received.

12. The gravity sensing input method as claimed in claim 7, wherein each of the input interfaces is a button or a keypad.

13. An electronic device, comprising:
a main body; and
a gravity sensing input system, comprising:
a gravity sensor configured for detecting a gravitational acceleration of the main body tilted towards a direction;
an input module, comprising a plurality of input interfaces, wherein each one of the input interfaces corresponds to a plurality of letters, and the input module is used for receiving an input signal through one of the input interfaces;
a processing module, connected to the gravity sensor and the input module, configured to calculate an inclined angle between the main body and a reference plane according to the gravitational acceleration, and determine which one of the letters is selected according to the inclined angle and the input interface corresponding to the received input signal; and
an output module, connected to the processing module, configured for outputting the letter selected by the processing module.

14. The electronic device as claimed in claim 13, wherein the gravity sensing input system further comprising:
a storage module, connected to the processing module, configured for storing the letters.

15. The electronic device as claimed in claim 14, wherein the gravity sensing input system further comprising:
a setting module, connected to the storage module, configured for setting an angle range corresponding to each one of the letters.

16. The electronic device as claimed in claim 15, wherein the different letters corresponding to one of the input interface are corresponding to the different angle ranges.

17. The electronic device as claimed in claim 16, wherein the setting module is connected to the processing module, and the processing module determines which one of the letters is selected by determining the inclined angle corresponding to which one of the angle ranges, and then by determining which input interface corresponding to the input signal is received.

18. The electronic device as claimed in claim 13, wherein each of the input interfaces is a button or a keypad.
